(19) United States
(12) Patent Application Publication
(10) Pub. No.: US 2013/0332182 A1
(43) Pub. Date: Dec. 12, 2013

(54) EVIDENCE-BASED PERSONALIZED DIABETES SELF-CARE SYSTEM AND METHOD

(71) Applicants: Gerene Delores SCHMIDT, Spokane Valley (Veradale), WA (US); Nelson Byron HAZELTINE, Chapin, SC (US)

(72) Inventors: Gerene Delores SCHMIDT, Spokane Valley (Veradale), WA (US); Nelson Byron HAZELTINE, Chapin, SC (US)

(21) Appl. No.: 13/914,077

(22) Filed: Jun. 10, 2013

Related U.S. Application Data
(60) Provisional application No. 61/658,357, filed on Jun. 11, 2012.

(51) Int. Cl. G06F 19/00

(52) U.S. Cl. CPC G06F 19/3437; G06F 19/322
USPC 705/2

(57) ABSTRACT

A personal, evidence-based, self-care information system for the management of diabetes, executing on a computer, receiving data input from a user, processing the data, and outputting results to the user, including a settings module; a glucose module; and a patterns module. A mobile device for the management of diabetes, including a memory, a processor, an input device, an output device, and a computer program executing on the processor, the computer program including a settings module, a glucose module, and a patterns module, and the glucose module receiving blood glucose measurement data input from a user through the input device, the patterns module analyzing the blood glucose measurement data in real time and outputting results of the analysis of blood glucose measurement data to the user. A computer-based method for the management of diabetes, receiving data input from a user, processing the data, and outputting results to the user, having the steps of inputting a target glucose range for the user; inputting a blood glucose measurement; inputting an event associated with the glucose measurement; and outputting information to the user.

The present invention is claims the benefit of previously-filed provisional application Ser. No. 61/658,357, filed Jun. 11, 2012, as provided in 35 USC §119(e) and 37 CFR §1.78(a).

### BACKGROUND OF THE INVENTION

The present invention is a personal evidence-based, self-care information system and method to better ensure competent personal management, outcomes and health status across time for progressive chronic diseases, beginning with diabetes Systematic reporting, monitoring and tracking of outcomes patterns include anticipatory/preventive care and prospective planning and management to achieve personal best outcomes with a planned migration pathway to automated pattern recognition and recommendations (Predictive Analytics) Early problem identification triggers detailed data collection to analyze, prompt and guide quick action to resolve adverse events and outliers such as out of acceptable range blood glucose values in real-time to stay on course with a prescribed health plan and prevent similar future adverse events and outliers

Focus for this patent is on Diabetes as a chronic condition which is not a stand-alone disease but a complex, chronic and progressive condition with co-existing diseases/conditions as well as organ damaging, systemic complications Multiple management strategies are required to address the complexity of diabetes for each individual at different times of physiological and biological changes over one's life span.

Most individuals/families with diabetes manage personal and family health 98% of the time. Only 1 to 2% is spent in the healthcare delivery system of which 90% is in a busy clinic or doctor's office. The time differential spent in each environment explains the need and challenge for individuals/families to learn to become more independent to self-manage without the frequent aid of professional guidance and education outside a quarterly clinic visit. Individuals' perception of control, as a result of growing independent and competent self-management, is critical to achieve as it leads to personal responsibility and accountability for one's health outcomes. This is important to achieve with each individual/family given the tsunami of diabetes around the globe.

This innovation is designed, developed and implemented to address and provide a solution for the most common problems in personal diabetes against the background of the characteristics of disease-oriented, medical practice in today's healthcare delivery system. Only 5 to 10% of the diabetes population receive care and education from an Endocrinology team. The remaining population is cared for by Family Practice and Internal Medicine teams who lack the time, specific knowledge and experience to adequately educate and care for the patient population with diabetes, 90% of whom have type 2 diabetes. Type 2 diabetes is especially challenging because of the paucity of knowledge about the nature of type 2 diabetes by those diagnosed and the general public. General practice elements that contribute to the current diabetes epidemic are performance failures to effectively diagnose, treat, educate and manage diabetes long-term. Fatigue, depression, exhaustion and boredom are common responses to the demands of long-term diabetes management by those diagnosed.

In the healthcare delivery system, the following are characteristics short falls in delivering long-term diabetes care: 1) retrospective analysis of cause of onset of illness or a chronic disease due to missing and lost information 2) false memory (individual erroneously recalling and reporting past contributing events to onset and management, 3) inconsistent, incomplete, uncoordinated care, 4) poor personalization of care due to lack of relevant, detailed individual information, 5) lack of systematic follow-up and monitoring of individual/family follow through and understanding of and adherence with recommendations and response to interventions thereby leaving outcomes to chance, 6) limited evidence-based medical care data, 7) incorrect diagnoses due to limited time to listen to the individual/family resulting in inappropriate treatment. Inappropriate treatment causes increased onset of costly acute illness and step care 8) wide variation in healthcare providers knowledge and experience 9) lack of transparency in care, costs and outcomes.

To date only minimal improvements in patient self-management and health outcomes using current products/services have been reported in professional journals.

There are no other products or technologies in the diabetes information and management market that provide comprehensive, in-depth, detailed and meaningful personalized information of an individual's self management and outcomes patterns with immediate synthesized information feedback in under a minute. Nor, do the episodic, retrospective, checklist formats of today's Electronic Medical and Personal Health Records weave a personal historical narrative over time and support prospective planning and management to achieve long-term personal best diabetes and health outcomes

### SUMMARY OF THE INVENTION

The present invention joins the emerging paradigm shift focusing on individual/family oriented daily health management distinct from today's acute illness and disease oriented healthcare services. The present invention as a personal diabetes management program collects and synthesizes an individual's data/information quickly in under a minute, consisting of patterns of outcomes resulting from self-management routine including choices, health habits, behaviors and lifestyle that reflect either competent, skilled self-management that promotes personal best diabetes and health outcomes or lack thereof that causes an individual to experience frequent patterns of adverse events and outliers (out of target blood glucose range) more than 15% of the time.

The invention is based on a whole life context and approach. Daily diabetes management is embedded within one's usual daily living routine rather than fitting one's life into a rigid diabetes regimen. Central to the emerging paradigm shift is the method and process of real-time, systematic data/information reporting, tracking and monitoring designed to achieve evidence-based self-care and beneficial, long-term outcomes. Evidence-based self-care informs and guides anticipating and prospectively planning management to achieve long-term, best personal self-management strategies to become or remain healthy. The concept of health is always about the future; becoming or remaining healthy.

The importance of evidence-based population wide self-care and outcomes hold promise to inform and enhance evidence-based medical care.

The four core modules that make up the present invention are Settings, Glucose, Patterns and Training (TIPS). The modules begin a growing comprehensive system, of which the four modules are the critical management core, to integrate future modules offering expanding data/information to manage conditions associated with diabetes, e.g., depression, hyperlipidemia, hypertension, systemic complications, obesity, cancer and more, with additional modules.

A feature of the present invention, as a personal diabetes management program, is to increase a perception of control, health literacy, confidence and independence in learning how to achieve competent self-management. This is important because diabetes is a progressive disease and usually a life-long condition that evolves through physiological and biological stages of growth/development and/or the aging process depending on the age at diagnosis Focus of the personal diabetes management program is on a daily living routine that encompasses changing, improving or maintaining productive lifestyle choices, habits behaviors and competent, skilled self-management strategies to make daily diabetes management easier and achieve personal best health outcomes.

A feature of the present invention is the use of smart devices, e.g., iPhone, iPod/iTouch, Droid, etc. The mobile smart device is held close to one's person and used as an extension of the hands and brain making it the best communication and information exchange tool to collect, analyze and produce immediate actionable information. Smart devices offer the platform for embedded intelligence in health information applications. It is expected that easier and better interpretation of personal information and health patterns leads to self-knowledge, understanding and more consistent application of knowledge to daily health and life management. Control over quality of life, productivity and energy through life stages and the aging process is advanced.

### BRIEF DESCRIPTION OF DRAWINGS

FIG. 1 is a graphic of one embodiment of the invention displayed on a smart device.

FIG. 2 is a block diagram of one embodiment of the invention, showing the interrelationship of the modules.

FIG. 3 is a flowchart of a method embodying the present invention.

FIG. 4 is a flowchart of a method embodying the present invention.

### DETAILED DESCRIPTION OF THE PREFERRED EMBODIMENT

The primary goal of the present invention is to support individuals/families to take control of daily diabetes management fitting into an overall daily living routine incorporating general health habits, choices and behaviors. Special focus is placed on developing the right habits, choices and behaviors that result in an individual's capability to competently manage to achieve personal best diabetes and health outcomes. The individual is his or her own standard for evaluating overall health status, progress or destabilization of health. Individual outcomes are also measured against established national standards of care and expected outcomes embedded in the application data collection and analysis processes to evaluate the narrowness or width of similarity or difference between individual outcomes and the standards of care.

The present invention design, methodology and value in the market provides a real-time, streamlined process and system of data entry, analyses and immediate information feedback to prompt not only quick response/action to identified problems, outliers and adverse events in real-time but also documentation of the interrelationships among the daily core management elements; meals/snacks, activity/exercise and medication and their effect on blood glucose values. Methods of analyzed data/information presentation in the Patterns Module make interpretation easier to see the results of self-management; areas of good management and where changes need to be made to achieve personal best outcomes.

The present invention is designed to be used by people with all types of Diabetes; Types 1, 1.5, 2, Gestational, MODY (Maturity Onset of Diabetes in Youth) and LADA (Latent Autoimmune Diabetes in Adults). In addition to the initial four modules; Settings, Glucose, Patterns and Training (TIPS) Modules, future modules are planned to address specific needs of people with associated conditions that must be managed with diabetes to stay on course and enjoy a desired quality of life with the foundation of a stable health status. Individuals with diabetes, as a progressive disease, benefit from prospective planning and management to become or remain healthy tomorrow and into the future. The present invention offers individuals/families the hope and control of sustaining personal best diabetes and overall health outcomes over the life span.

The design of the invention is mapped on the total daily activities required for competent self-management of diabetes. Specific focus is on a system and method for detecting daily living habits and choices that contribute to blood glucose outlier patterns that eventually lead to serious systemic complications. The present invention is specifically designed to capture high and low blood glucose patterns and associated information as to frequency, timeframes, symptoms, cause, treatment, results and response time to return to a prescribed blood glucose target range. The target range is personalized and can be set by the individual/family in the Settings Module. Each data point entered is time stamped.

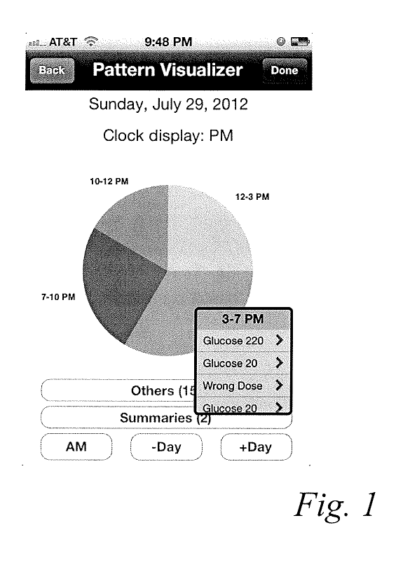

In one embodiment, shown in FIG. 1, the present invention streamlines and structures patient/family reporting on a smart device, e.g., but not limited to, smart phone, to collect data/information related to the three interrelated daily management activities, i.e., food intake, activities/exercise and medication to analyze their effect on blood glucose values. The present invention as a privately controlled, personal information application is designed to analyze and integrate blood glucose values with food intake, medications and exercise in multiple presentation formats including a 24 hour clock (12 hour AM and PM clocks) to demonstrate the results and response patterns of daily management. This information presentation of management results and patterns is a more familiar visual and understandable format than older methods of scatter grams, pie charts and bar graphs. The majority of individuals/families either can't or have difficulty interpreting and transferring information in scatter grams, pie charts and bar graphs to daily management planning, decisions and actions. The 24 hour clock method of data/information presentation is designed to empower and support the patient and family to see and more easily interpret, through immediate information analysis and feedback, personal health patterns, habits, lifestyle choices and behaviors that result in the quality of health outcomes.

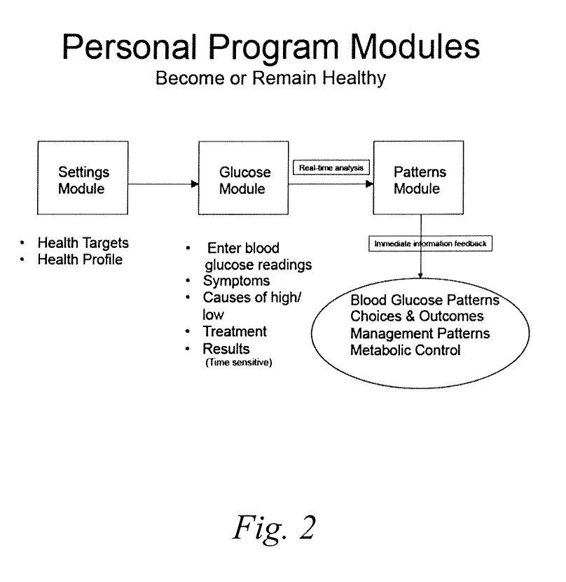

Refer to FIG. 2 for the following description.

The Settings Module contains historical baseline clinical data and demographics. The Glucose Module allows the individual/family to report blood glucose readings, e.g., normal, high, low and wide swings between high and low values including in-depth, detailed and meaningful data associated with the readings. Events associated with high, low or wide glucose swings are reported in the Glucose Module, specifically, the time of an event associated with an out-of-range glucose reading, the glucose reading(s), symptoms, possible causes, treatment, results and response time, i.e., the time it took to return to the prescribed blood glucose target range and achieve a stable health status. Examples of an event may be associated with, but are not limited to, intense exercise, too little exercise, sports, illness, infections, trauma, depression or psychological states such as depression. The present invention is designed to spot problems early and identify patterns that need evaluation for possible intervention and education to anticipate and prevent the same event from happening in the future. This is the anticipatory care function in the application. The anticipatory care function sets the stage for prospectively planning the future health pathway to achieve personal best health outcomes rather than leaving outcomes to chance.

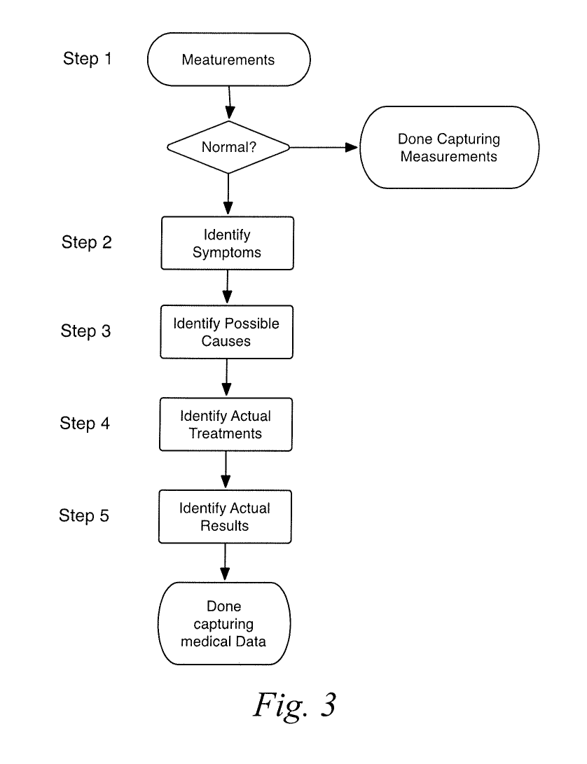

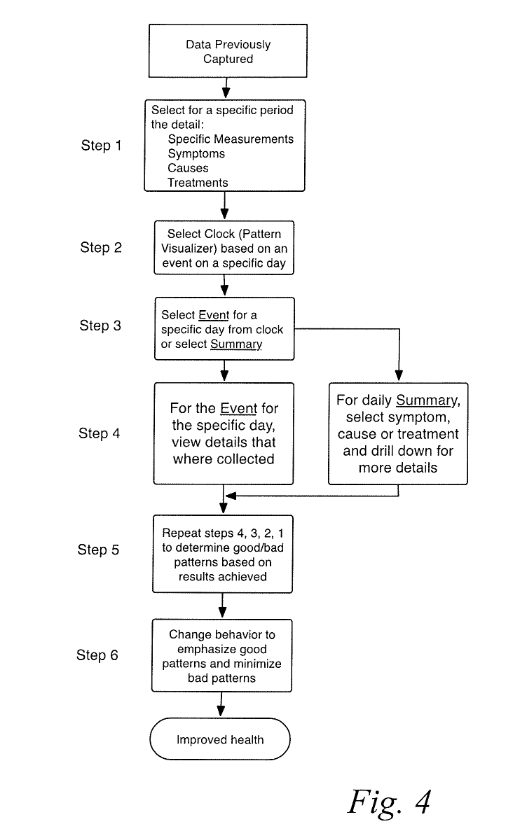

Refer to FIGS. 3 and 4 for the following description.

All data and information in the Settings and Glucose Modules are immediately analyzed and results sent to the Patterns module. Patterns result from analysis of frequent reporting of meals/snacks, activities/exercise and medications to reflect their relationship and effect on blood glucose values and metabolic control. The Training or TIPS Module explains how to use the Modules to assist in achieving competent management.

Detailed data is analyzed and presented in diverse presentation formats in the Patterns Module. Immediate information feedback is accessible upon reporting outliers, problems or an adverse event. The Patterns Module highlights the daily as well as aggregate outcomes resulting from ineffective habits, choices and behaviors. Interpretation of data/information is made easier through visualization of one's patterns in various ways. The individual/family can see when to seek help or where to adjust diet, exercise, medications or a daily routine as needed to achieve blood glucose target range and good metabolic control.

In one embodiment (see FIG. 1), the Patterns Module provides several ways to view the data and corresponding patterns including a pie chart that reports the percentage of time one is in high, low or normal blood glucose levels. Also available is a vertical list of blood glucose readings, time stamped, with a timeframe (before/after meals, daily activities, exercise, medications, bedtime, during sleep and random). One can select to look at 10, 14 and 30 days of blood glucose readings. The eye can quickly scan and see blood glucose trends. An AM and PM clock provides a 24 hour detailed view of blood glucose levels, events, causes, symptoms, treatments and results in each marked time sector. The clock is designed to assist with easier interpretation of data and information the individual/family entered to reflect where best choices, habits and management are yielding the best outcomes and where improvements or changes may be needed to improve management and outcomes.

The four core management modules assist the user to better control and achieve competent daily self-management. More modules can be added depending on the information needs of individuals and families. A prospective, non-limiting example is a module for depression and mental health, common to long-term diabetes management when individuals become tired of daily management. To relieve the fatigue and boredom with daily management, the present invention establishes, monitors and conducts long-term tracking of patterns and recommends, dependent on the individual's personal patterns, the frequency of reporting their daily self-management regimen to detect the need for changes in medication, diet or activity/exercise to obviate fatigue, stay on course and maintain overall health. The innovation and improvement over previous and existing products and services that are episodic, disease-oriented and from the medical perspective are: 1) systematic patient reporting, documenting, monitoring and tracking of the patient's long-term response patterns, 2) compliance with management protocols, 3) feedback in patterns on habits, lifestyle choices and behaviors, 4) prospective planning and management to become or remain healthy, 5) manage for personal best outcomes rather than leaving outcomes to chance, 6) educating via the training (TIPS) module to guide the user to learn at one's personal pace about diabetes and monitor diabetes as a progressive disease over time to make adjustments where needed to stay on course with prescribed target health goals.

Incentives to continue to use the present invention over the long term of living with diabetes can be added.

The present invention overcomes the limitations of current diagnosis, intervention and information/care methods and processes to quickly provide real-time, in-depth data entry and analysis in an average time of about 15 to 20 seconds for the experienced user. Entering normal blood glucose values takes on average about 3 seconds as there is no further data entry necessary. There are no systematic, long-term solutions in place today that account for the fact that diabetes is a progressive disease across the lifespan. Physiological and biological stages of growth, development and aging and their associated changes within the context of one's life with diabetes, require monitoring and on-time adjustments in management strategies to achieve an individual's best quality of life and prevent, delay, mitigate or reverse complications and co-morbid diseases.

An objective and feature of the present invention is to enable an individual to become more independent through ongoing, on-time monitoring of progress or destabilization of one's diabetes and health status. A feature is providing education at the time one needs information to manage blood glucose outliers, problems or adverse events with prompts to guide quick response and return to a prescribed blood glucose target range. A benefit of frequent use of the application is to help establish a daily routine to make life easier, eliminating the need to constantly think through every management element. Lack of a daily routine may also lead to mindless management, i.e., inattention until one's becomes ill or experiences onset of complications of body systems.

Achieving gradually increasing knowledge and skills at one's personal pace at the point in time when needed and is “top of mind” promotes competent self-management and replaces waiting to be told what to do between quarterly doctor visits when it is too late to accurately recall important details. That is: 1) learn to spot and identify outliers, problems or adverse events early, and, 2) reason through and act promptly to resolve outliers, problems or adverse events as a result of understanding and being able to correctly apply appropriate management protocols.

The reporting and data entry process in the present invention provides entering a timeframe of the blood glucose, e.g., before/after meals, daily activities, exercise, and medications. When outliers of high or low blood glucose values or wide swings between high and low values are identified, the associated in-depth reporting automatically goes to the appropriate pathway to enter symptoms, causes, treatment, results and response time, i.e., the time it took to return to a prescribed blood glucose target range. The normal, high and low pathways are color coded so that the individual knows he/she is entering data in the appropriate path. The time-stamped, detailed data/information reflects impact on diabetes and overall health outcome patterns across time. Patterns information is designed to provide several presentation formats to make personal interpretation of management and related outcomes easier, helping the individual/family to become more independent in decision-making and making relevant changes in daily management. Daily management becomes easier through forming a daily routine of the right habits, lifestyle choices and behaviors, all of which are confirmed or highlighted in patterns to see where success is achieved or changes, improvements or adjustments should be made.

The cumulative data/information is analyzed to reveal patterns to educate, guide and anticipate future health events based on habits, lifestyle choices and behaviors. In the case of problems, blood glucose outliers and adverse events, the individual is guided through a time stamped process of entering relevant data that integrates and analyzes total daily activities of meals/snacks, activity, exercise/sports and medications to reveal where errors or failures in management exist to competently coordinate these interrelated elements. The analyzed data is reflected in the Patterns Module to achieve pattern recognition that is used to prospectively manage for best personal outcomes in the future. The method and process in the present invention through data collection and immediate analyses produces personalized visual patterns in several different data presentation formats in the Patterns Module to address user preferences for reviewing and evaluating self-management, habits, lifestyle choices and behaviors. The method and processes are designed to reflect where good management is achieved as revealed by outcomes and where changes in habits, choices and behaviors are indicated.

The ultimate information from the invention is to guide the individual and the healthcare team to improve management and outcomes that results in improved metabolic control. The summarized information that determines the category of metabolic control resides in the Metabolic Control section in the Patterns Module The critical elements in the Metabolic Control section are: 1) the number of blood glucose readings, 2) the number of high and low outside an individual's prescribed target rang 3) ketones associated with high blood glucose values, 4) wrong medication doses that caused high or low blood glucose values 5) number of blood glucose values before meals of 70-100 6) number of blood glucose values at 1 and/or 2 hrs after meals at least under 180 7) number of blood glucose values 80 to 150 at bedtime 8) number of blood glucose values of 70 to 150 during the night. The foregoing are combined with A1c values every 3, 6, 9 or 12 months, extra MD office visits, Emergency Room visits and/or hospitalizations for adverse events. Combined all these elements are determinants for categories of good, fair, poor or very poor metabolic control. The Metabolic Control section provides a comprehensive picture of the individual's competence and skill in self-management, level of understanding and application of knowledge to self-management as well as collaboration with a healthcare team who may also have deficits in knowledge and service. The categories of metabolic control are a guide to the need for frequency of ongoing monitoring, continuing close observation and care by the healthcare team and education needs. The present invention specifically supports anticipatory and preventive care, prospective planning and management to help an individual/family to manage to remain or become healthy, i.e., maintain or achieve one's personal best health outcomes.

Method

The Capturing of Data for Analysis

Step 1 Data Collection Specific to Diabetes Management
Blood Glucose Readings and related data: timing of food, activity, exercise and medications.
If blood glucose readings are within a prescribed target range, also called “normal” for a given individual, then no further data is collected. The assumption is that the individual is managing food, activity, exercise and medications to achieve blood glucose target range and good metabolic control, the latter,
if about 85% of the time. Done capturing measurements and the timeframes in which they occurred such as before or after meals, snacks, activities, exercise, medications.

The personal diabetes management program is meter agnostic, numbers data from all meters on the market can be entered manually. Although there may be a downside of manually entering numbers due to human error, there are safeguards to collect as accurate information as humanly possible than can be used for effective self-management and communication of data and information to the healthcare team. These are: 1) adequate education and demonstration of use and purpose of the program, immunoassay tests such as the HgbA1c that reflects the level of blood glucose control and thereby determines Metabolic Control. Meter specific uploads directly from a meter to the smart phone technology limits the number of people who can afford and use the personal diabetes management program though it is anticipated that this will be offered in future product releases.

Blood Glucose Values Outside an Individual's Prescribed Target Range

Step 2 Data Collection Specific to Blood Glucose Outliers, high or low outside the prescribed target range.
A, Two Pathways, color coded to enter outlier blood glucose data. Orange is for high blood glucose outliers and violet for low blood glucose outliers. The color code for normal is blue.
Enter symptoms from a list of common symptoms for each high and low.
Enter “other” if the symptoms experienced are not on one of the lists.

Step 3 Pursuant to the pathway selected by entering a high or low blood glucose value, the individual is asked to identify and enter possible causes to orient one and raise consciousness as to why patterns of adverse events associated with high or low or wide swings in high and low blood glucose values are happening.

Step 4 Following on entering data for symptoms and possible causes, the individual decides to 1) call the doctor or team 2) determine the treatment to perform oneself 3) go to the ER that may be followed by discharge following treatment or hospitalization depending on the individual's stable or unstable status despite treatment.
The actual treatment is entered. If treatment for high blood glucose, the treatment data can be entered at the time of treatment. If treatment for low blood

Glucose, treatment data is entered after returning to a stable state and target range blood glucose values since low blood glucose is always considered an Emergency. The individual doesn't use the system at or during a low blood glucose episode but is encouraged to enter the data after the fact to render the data in the Patterns Module as accurate as possible, for example, that the percentages for normal, high and low are accurate on the first screen in the Patterns Module.

Warnings related to high and low blood glucose values according to national standards of care are placed at critical points of data entry. For example, if a high blood glucose is 300 or above, the individual is advised to test for ketones. For low blood glucose levels an individual is advised that a low blood glucose value is always a medical emergency and should be treated immediately. Enter data into your personal diabetes management program after the fact.

Step 5 Actual Results are entered with blood glucose reading and timeframe so it can be evaluated as to how long and how much treatment was required to return to an individual's prescribed blood glucose target range from a high or low or wide swings between high and low blood glucose values.

Done capturing blood glucose, symptoms, possible causes, actual treatments and treatment results.

Utilizing Captured Data to Visualize Patterns and Better Manage Health Status

Data entered in real-time in the Glucose Module is now integrated with historical data from the Health Profiles in the Settings Module. The personal diabetes management program now integrates the historical data in Health Profiles with the Glucose Module and sends it immediately to the Patterns Module for immediate information feedback. The value of the immediate feedback is to more easily see, using different visual techniques such as a pie chart, vertical lists of blood glucose readings and associated data and AM and PM clocks, the effect of an individual or family's results from self-management or interaction with the healthcare delivery system, i.e., doctor/team, Emergency Room or Hospital. In some cases the healthcare delivery system may be an Urgent Care, Immediate Care or Outpatient Clinic or Services. The school system may be involved if the child is of school age and a blood glucose outlier and/or an adverse event happens during school hours.

Step 1 The individual/family touches the Patterns Module icon and proceeds to select a specific time period to look at, interpret and evaluate the data in the Patterns Module for a specific blood glucose or for 10, 14 or 30 days to be able to more easily see and interpret trends and patterns resulting from self-management of a daily routine of choices, habits and behaviors that affects diabetes and general health outcomes.

The first screen in the Patterns Module shows the pie chart that has automatically been tracking all blood glucose values entered by the individual or family.

The percentages of normal, high and low blood glucose readings are displayed in the pie chart in percent numbers and color coded: blue is normal, orange is high and low is violet to correlate with the blood glucose data entry pathways in the Glucose Module. This is to help the individual/family to visually follow and understand how to use and see the blood glucose pathways with their associated relevant data and timing: food, activity, exercise and medications. Photo and Audio data may also be accessed in the Patterns Module as a result of entering photos, text or verbal descriptions of food intake.

The first screen, in addition to the pie chart, provides Glucose Reading Detail, Symptoms Detail, Cause Detail, Treatment Detail and Metabolic Control.

The Glucose Reading Detail provides: Date, Time, GUR (Glucose Reading), D (Determination, TF (Time Frame) and CLK (AM and PM Clocks)

The AM and PM Clocks serve to provide a 24 hour view of one's management and results. The Symptoms, Cause and Treatment screens provide Date, Time, Symptoms, Cause or Treatment and the Clock.

Step 2 The Clock when selected presents another method of visualizing patterns including specific outlier event data such as carbs, food (photos, audio), activities, exercise and medications, correlating them with specific blood glucose values. This is to give the individual/family an overall view of the total elements related to a high or low outlier blood glucose value. The goal is easier interpretation through this visual presentation to guide and help see where changes may need to be changed: diet, activity, exercise and/or medication(s), dose, time, type, route.

Specific days can be selected by pressing the +days or −days from a day being displayed.

Step 3 Select an Event for a specific day from the clock to select a Summary. Symptoms, causes, or treatments can be drilled down for more details.

Claim I

My Diabetes Success is a unique model for collecting data on smart phone/smart devices as well as any superset containing this model or a subset. Refer to FIG. 1.

Step 1 Take a measurement, for example, a Blood Glucose measurement

Step 2 Identify symptoms, for example, blurred vision

Step 3 Identify possible abnormal causes, for example, wrong dose

Step 4 Identify actual treatments, for example, Glucagon injection

Step 5 Identify actual results, for example, a blood glucose measurement closer to the normal range

Measurements, symptoms, causes, treatments, and results are called events, each being a type of event. A data point represents each event. A data point can consist of the type of event, date and time, timeframe (before breakfast, etc.), severity, medication, dosage, etc. Data points can be entered via keyboard, voice, camera (pictures/video) or from other disease related devices such as a glucose meter.

Customize personal and complete data collection in real-time from the individual/family using the smart phone/device technology. The individual/family reports by responding to a personalized as well as standardized question dataset, which allow free expression for data input where text, voice, camera or other devices can be used.

Claim II

Unique model for visualizing patterns, as well as any superset containing this model and any subset. Refer to FIG. 2.

Step 1 For a specific period (for example 10, 14, or 30 days), select measurements, symptoms, causes, and treatments, i.e., a type of Event. This produces a list of Events for the type of Event selected for the specific period.

Step 2 Select Clock (pattern visualizer) associated with an Event for a specific day from the list of Events. Refer to Claim 6. A clock is displayed.

Step 3 Select an Event for a specific day from the Clock.

Step 4 For the Event for the specific day, view the data point that was collected.

Step 5 Repeat Steps 4, 3, 2, 1 to determine good/bad patterns relative to a target range of measurements.

Step 6 Change personal behaviors to emphasize good patterns and minimize bad patterns relative to the target range of measurements.

This results in a closed loop system, i.e., an initial series of measurement Events lead to a pattern that, in turn, leads to improvements which leads to another initial series of measurement Events.

Claim III

Tailoring the individual/family's real time perspective and insight into self-care through the data question sets, then immediately analyzing and providing integrated information feedback on the management of the interrelationships of meals/snacks, activity/exercise and medications and their effect on blood glucose values that reflect self-management knowledge, competence and results.

Educate patients/families in real-time with immediate information feedback to augment learning and the best self-management strategies that yield the best results at a personal pace over time; prompt and guide quick response and action to address and resolve health problems, adverse events or incorrect knowledge of management protocols to stay on course, i.e., obviate veering off course. This is designed to teach to anticipate and prevent future problems, adverse events or inaccurate application of management protocols by immediately reflecting results in the Patterns Module.

The events and associated data points are collected and passed on to the Pattern Analyzer where i above can be realized.

Claim IV

Ease of capturing relevant information increases motivation by offering valuable immediate information feedback in the Patterns Module. The time between collection and analysis is too long today. By systematically collecting and analyzing information in real-time, user motivation is increased to the point where data is timelier and more accurate. It is the interaction between the collection model and the pattern (analysis) model that provides support to this claim.

Claim V

Integrated pattern analysis of diabetes related biological and physiological parameters, health status, habits, lifestyle choices, behaviors, meals/snacks, activities/exercise and medications that impact blood glucose values and reflect metabolic control.

i. Tailored to the individual's manifestation of diabetes, personalized parameters and prescribed blood glucose target range.

ii. Nutritional data/information, report dietary intake (meals/snacks) by voice, text and camera when blood glucose values are high or low, outside one's prescribed target range.

Claim VI

Integration of time and clock charts by sector that deliver real-time data visualization. The clock charts are divided into sectors that enable the total data and results for each 24 hour period over 10, 14 and 30 days. Entire data sets, time stamped for each event associated with a timeframe (before/after meals, exercise, medications) and an outlier blood glucose value, including carbs, food intake, activity/exercise, medications causes, treatments, results and response time. The clock is designed to help the individual/family to detect patterns more easily.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A personal, evidence-based, self-care information system for the management of diabetes, executing on a computer, receiving data input from a user, processing the data, and outputting results to the user, said system comprising:
a. a settings module;
b. a glucose module; and
c. a patterns module.

2. The system of claim 1, wherein the settings module further comprises historical baseline data and demographics.

3. The system of claim 2, wherein said historical baseline data and demographics further comprises a target glucose range for a user of the system.

4. The system of claim 1, wherein the glucose module further comprises data on blood glucose measurements and events associated with said blood glucose measurements.

5. The system of claim 4, wherein said blood glucose measurements further comprise normal, high, low, and swings between said high and low values.

6. The system of claim 5, wherein high and low blood glucose measurements automatically prompt a user of the system to enter symptoms, causes, treatment, results, and response time.

7. The system of claim 5, further comprising the time of each event, the glucose reading at that time, possible causes of the glucose reading, possible treatment, results of intervention, and the response time needed to return said glucose reading to a normal range.

8. The system of claim 5, wherein said events are selected from the group consisting of: intense exercise, too little exercise, sports, illness, infections, trauma, depression, and other psychological states.

9. The system of claim 1, wherein the patterns module receives analyzed data and information from the glucose module and the settings module.

10. The system of claim 9, wherein said information and data is analyzed in real time.

11. The system of claim 10, wherein the patterns module provides immediate information feedback to the user of the system.

12. The system of claim 11, wherein said immediate information feedback further comprises outliers, problems, and adverse events.

13. The system of claim 12, wherein said immediate information feedback further comprises output from the information system to the user.

14. The system of claim 13, wherein said output further comprises a pie chart reporting the percentage of time that the glucose reading was at a high, low, and normal level.

15. The system of claim 13, wherein said output further comprises a list of time-stamped glucose readings.

16. The system of claim 15, wherein said time-stamped glucose readings further comprise events, causes, symptoms, treatments, and results.

17. The system of claim 1, further comprising a training module instructing the user on how to use the system.

18. The system of claim 13, wherein said output further comprises a time frame selected from the group consisting of: before/after meals, daily activities, exercise, medications, bedtime, during sleep, and random.

19. The system of claim 18, wherein said output further comprises an AM and PM clock.

20. A mobile device for the management of diabetes, said device further comprising a memory, a processor, an input device, an output device, and a computer program executing on said processor, said computer program further comprising a settings module, a glucose module, and a patterns module, and said glucose module receiving blood glucose measurement data input from a user through the input device, said patterns module analyzing said blood glucose measurement data in real time and outputting results of said analysis of blood glucose measurement data to the user.

21. The mobile device of claim 20, wherein said glucose module receives event data input from the user through the input device, wherein said event data is associated with said blood glucose measurement data.

22. The mobile device of claim 21, wherein said blood glucose measurement data further comprise normal, high, low, and swings between said high and low values.

23. The mobile device of claim 22, wherein said analysis of blood glucose measurement data further comprises the time of each event, the blood glucose reading at that time, possible causes of the blood glucose reading, possible treatment, results of intervention, and the response time needed to return the blood glucose reading to a normal range.

24. The mobile device of claim 23, wherein said output results further comprise a pie chart reporting the percentage of time that the blood glucose reading was at a high, low, and normal level.

25. The mobile device of claim 24, wherein said output results further comprise a list of time-stamped glucose readings.

26. The mobile device of claim 25, wherein said time-stamped glucose readings further comprise said event data, said possible causes of the blood glucose reading, said possible treatment, and said response time needed to return the blood glucose reading to a normal range.

27. A computer-based method for the management of diabetes, receiving data input from a user, processing the data, and outputting results to the user, comprising the steps of:
a. inputting a target glucose range for the user;
b. inputting a blood glucose measurement;
c. inputting an event associated with the glucose measurement; and
d. outputting information to the user.

28. The method of claim 27, wherein the event is selected from the group consisting of: symptoms, causes, treatments, and results.

29. The method of claim 28, further comprising a data point representing the event.

30. The method of claim 29, wherein the data point is selected from the group consisting of: type of event, date and time, timeframe, severity, medication, and dosage.

31. The method of claim 30, further comprising at least one repetition of steps (b) through (d).

32. The method of claim 31, further comprising the user selecting a specific period for displaying events and selecting a type of event to display.

33. The method of claim 32, wherein step (d) further comprises outputting a list of events for the period and type of event selected.

34. The method of claim 33, wherein step (d) further comprises displaying a clock associated with an event from the list of events.

35. The method of claim 34, wherein step (d) further comprises selecting an event for a specific day from the clock.

36. The method of claim 35, wherein step (d) further comprises displaying the data point associated with the event.

37. The method of claim 27, further comprising at least one repetition of claims 32 through 36.
